(19) United States
(12) Patent Application Publication
(10) Pub. No.: US 2008/0179233 A1
(43) Pub. Date: Jul. 31, 2008

(54) SCUM REMOVING UNIT FOR WASTEWATER FLOTATION TANK

(76) Inventor: CHENG-HUA SHEN, Taipei County (TW)

Correspondence Address: CHARLES C.H. WU, 98 DISCOVERY, IRVINE, CA, 92618-3105, US

(21) Appl. No.: 11/846,936

(22) Filed: Aug. 29, 2007

(30) Foreign Application Priority Data
Jan. 26, 2007 (TW) 096201671

(51) Int. Cl. C02F 1/24

(52) U.S. Cl. 210/221.2

(57) ABSTRACT

A scum removing unit for wastewater flotation tank includes a driving element; a shaft mechanism being driven by the driving element to rotate and having a rotating element mounted thereon; and a suspension arm being associated with the rotating element. The suspension arm has a lower end extended into a wastewater flotation tank and having at least one scraper fixed thereto. When the rotating element is rotated, the suspension arm is brought to move along a predetermined path, and the scraper at the lower end of the suspension arm is caused to scrape off scrum in the wastewater flotation tank along the predetermined path. Except for the scraper, all the parts of the scum removing unit are not in contact with the scum, protecting the scum removing unit against rust and resultant damage.

### FIELD OF THE INVENTION

The present invention relates to a scum removing unit for wastewater flotation tank, and more particularly to a scum removing unit for wastewater flotation tank that includes a scraper extended into a wastewater flotation tank for removing scum from the tank, and a transmission mechanism located distant from liquid and scum in the wastewater flotation tank to thereby reduce damage and loss of the scum removing unit.

### BACKGROUND OF THE INVENTION

Most conventional wastewater flotation apparatus have a scum filtration tank for rear-stage treatment operation. The scum filtration tank is normally provided with a scum removing structure, such as a scum removal trough located near an upper end of the scum filtration tank, so that scum on a water surface higher than the scum removal trough automatically flows out of the scum filtration tank via the scum removal trough. In the case of treating the seriously polluted water, the scum produced in the scum filtration tank usually has a relatively high concentration or a relatively large amount, and the scum removal trough is not large enough for quickly discharging the large amount of scum. Under this condition, an apparatus assisting in removing the scum is often provided on the wastewater flotation apparatus. For example, a track mechanism is provided over the scum filtration tank near the water surface with scum, so that a plurality of scrapers is reciprocated on the water surface to push the scum to the scum removal trough for discharging.

To enable effective removal of the scum, the track mechanism is usually mounted very close to the water surface for the scrapers to locate on the water surface. Due to the short distance between the track mechanism and the water surface, the scum tends to attach to the track mechanism to adversely affect the smooth operation of the track mechanism. Therefore, the track mechanism requires frequent maintenance and replacement of parts. This is troublesome for a user to do so and requires improvement.

### SUMMARY OF THE INVENTION

A primary object of the present invention is to provide a scum removing unit for wastewater flotation tank that has a scraper extended into a wastewater flotation tank for removing scum from the tank, and a transmission mechanism located distant from liquid and scum in the wastewater flotation tank to reduce damage and loss of the scum removing unit.

To achieve the above and other objects, the scum removing unit for wastewater flotation tank according to the present invention includes a driving element; a shaft mechanism being driven by the driving element to rotate and having a rotating element mounted thereon; a coupling mechanism, via which the driving element drives the shaft mechanism to rotate; a suspension arm being eccentrically connect at a pivot end to the rotating element; and a support for supporting the shaft mechanism thereon and having a guide section for interfering with the suspension arm. A lower end of the suspension arm opposite to the pivot end is extended into a wastewater flotation tank and has at least one scraper fixed thereto for scraping off the scum in the wastewater flotation tank. The suspension arm includes an interference section associated with and interfered by the guide section. When the shaft mechanism is driven by the driving element to rotate, the suspension arm is brought by the rotating element and guided by the guide section to move in predetermined directions, so that the scraper at the lower end of the suspension arm is moved along a predetermined operating path to remove scum from the wastewater flotation tank.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a scum removing unit for wastewater flotation tank according to an embodiment of the present invention;

FIGS. 2 and 3 are sectioned side views showing the movements of the scum removing unit for wastewater flotation tank of FIG. 1; and

FIG. 4 is a sectioned side view showing the use of the present invention to remove scum from a wastewater flotation tank.

### DETAILED DESCRIPTION OF THE PREFERRED EMBODIMENTS

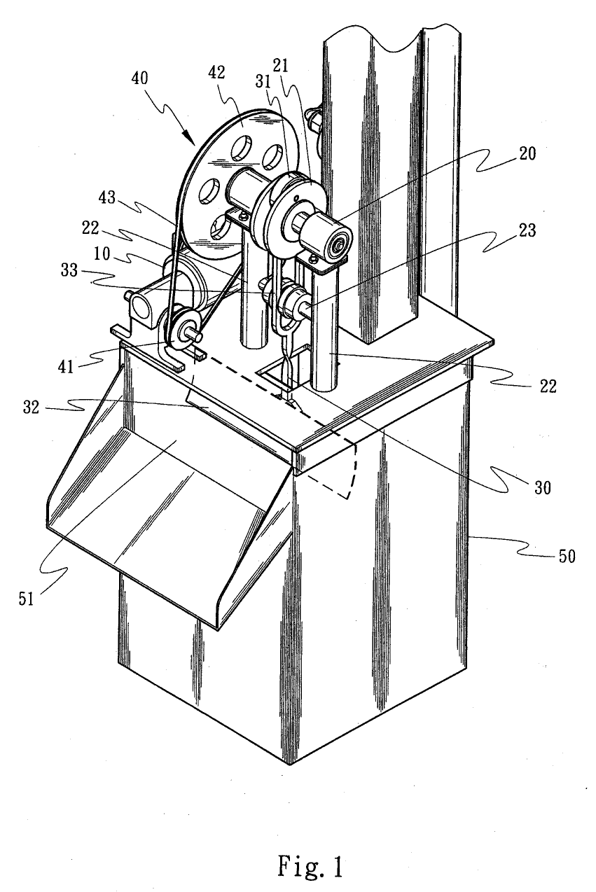

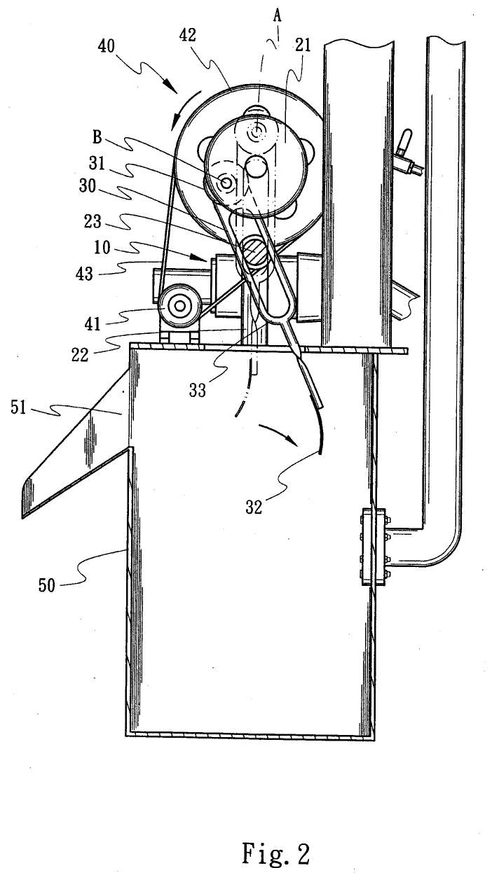

Please refer to FIGS. 1 and 2, in which a scum removing unit for wastewater flotation tank according to an embodiment of the present invention is shown. The scum removing unit includes a driving element 10, which is an electric motor in the illustrated embodiment for driving a shaft mechanism 20, and a coupling mechanism 40, which includes a driving pulley 41 mounted on the driving element 10, a driven pulley 42 mounted on the shaft mechanism 20, and a pulley belt 43, via which the driving pulley 41 brings the driven pulley 42 to rotate. A rotating element 21 in the form of a round disc is mounted on the shaft mechanism 20 to eccentrically connect to a suspension arm 30 at a pivot end 31 thereof. A lower end of the suspension arm 30 opposite to the pivot end 31 is extended into a wastewater flotation tank 50 and has at least one scraper 32 fixed thereto for scraping off scum in the wastewater flotation tank 50. A support 22 is provided on a top or a peripheral wall of the wastewater flotation tank 50 for supporting the shaft mechanism 20 thereon, so that the shaft mechanism 20 is arranged over the wastewater flotation tank 50. The support 22 includes a horizontal guide section 23 interfering with and accordingly guiding the suspension arm 30 to move in predetermined directions.

In the illustrated embodiment, the suspension arm 30 includes an interference section 33 located in the vicinity of the pivot end 31 and in the form of a hollow slide rail; and the guide section 23 is correspondingly configured as a bar for extending through the hollow slide rail of the interference section 33. When the driving element 10 drives the shaft mechanism 20 and accordingly, the rotating element 21 to rotate, the suspension arm 30 eccentrically connected at the pivot end 31 to the rotating element 21 is brought to move downward and upward while being guided by the guide section 23 at the interference section 33. At this point, the scraper 32 fixed to the lower end of the suspension arm 30 is caused to move in the wastewater flotation tank 50 in a circular motion to scrape off the scum.

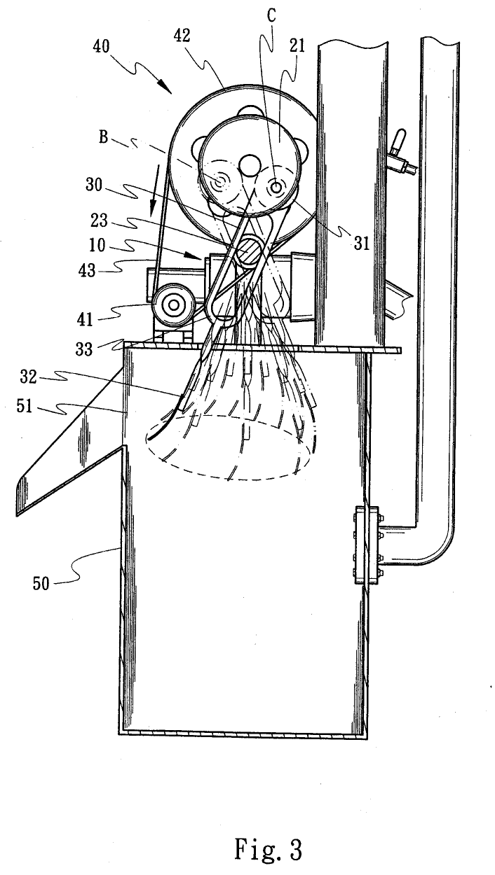

Please refer to FIGS. 2 and 3 that are sectioned side views showing the movements of the scum removing unit for wastewater flotation tank according to the present invention. When the driving motor 10 is started to rotate the driving pulley 41, the driven pulley 42 and accordingly, the shaft mechanism 20 are brought to rotate along with the driving pulley 41 via the pulley belt 43. At this point, the rotating element 21 on the rotating shaft mechanism 20 brings the suspension arm 30 to move upward and downward. With the guide section 23 extended through the interference section 33 of the suspension arm 30, the suspension arm 30 is guided by the guide section 23 when it is moved upward and downward. This brings the scraper 32 in the wastewater flotation tank 50 to displace along a path as indicated in FIG. 3. More specifically, when the pivot end 31, at where the suspension arm 30 is eccentrically and pivotally connected to the rotating element 21, is displaced from the position A to the position B in FIG. 2 in a direction indicated by the upper arrow, the scraper 32 is moved downward from its highest position in a direction indicated by the lower arrow in FIG. 2; and when the pivot end 31 is displaced in the same direction from the position B to the position C as shown in FIG. 3, the scraper 32 is moved forward from a rear position.

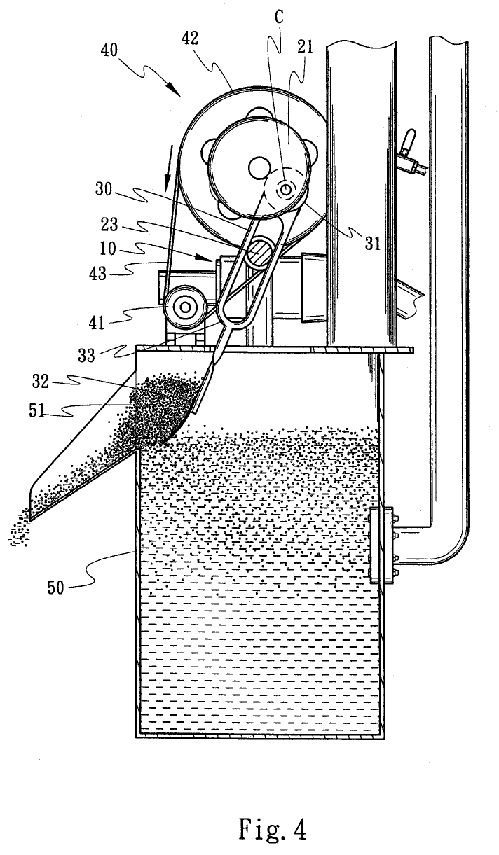

Please further refer to FIG. 4. When the scum removing unit according to the present invention is used to remove scum from the wastewater flotation tank 50 in the above-described operating manner, the driving element 10 drives the rotating element 21 to bring the suspension arm 30 and accordingly, the scraper 32 to cyclically move along a predetermined path. The driving element 10 may be adjusted to a different rotating speed according to the amount of scrum in the wastewater flotation tank 50, so that the scraper 32 may be moved at a speed best for pushing the scum to a scum removal trough 51 on the wastewater flotation tank 50. In another operable embodiment, the suspension arm 30 has a plurality of scrapers 32 fixed to the lower end thereof. Alternatively, the scraper or scrapers 32 are designed to have different configurations or shapes to increase the efficiency of removing the scum.

With the above arrangements and operating manner, only the scraper 32 and/or a small lower part of the suspension arm 30 in the scum removing unit of the present invention is in actual contact with the liquid and scum in the wastewater flotation tank 50. All other structural parts of the present invention are located high above the operating environment of the wastewater flotation tank 50 without the risk of being subjected to damage and frequent maintenance due to contact with the liquid and scum.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A scum removing unit for wastewater flotation tank, comprising a driving element; a shaft mechanism being driven by the driving element to rotate and having a rotating element mounted thereon; and a suspension arm being associated with the shaft mechanism at the rotating element, and having a lower end extended into a wastewater flotation tank with at least one scraper fixed thereto; whereby when the driving element drives the shaft mechanism to rotate, the lower end of the suspension arm is brought by the rotating element on the shaft mechanism to cyclically move in the wastewater flotation tank along a predetermined path.

2. The scum removing unit for wastewater flotation tank as claimed in claim 1, further comprising a guide section for guiding the suspension arm to move along the predetermined path.

3. The scum removing unit for wastewater flotation tank as claimed in claim 2, wherein the suspension arm includes an interference section associated with the guide section.

4. The scum removing unit for wastewater flotation tank as claimed in claim 3, wherein the interference section is in the form of a slide rail.

5. The scum removing unit for wastewater flotation tank as claimed in claim 1, further comprising a support for supporting the shaft mechanism thereon.

6. The scum removing unit for wastewater flotation tank as claimed in claim 2, further comprising a support for supporting the shaft mechanism thereon.

7. The scum removing unit for wastewater flotation tank as claimed in claim 3, further comprising a support for supporting the shaft mechanism thereon.

8. The scum removing unit for wastewater flotation tank as claimed in claim 6, wherein the guide section is provided on the support.

9. The scum removing unit for wastewater flotation tank as claimed in claim 7, wherein the guide section is provided on the support.

10. The scum removing unit for wastewater flotation tank as claimed in claim 2, wherein the guide section is in the form of a guide bar.

11. The scum removing unit for wastewater flotation tank as claimed in claim 3, wherein the guide section is in the form of a guide bar.

12. The scum removing unit for wastewater flotation tank as claimed in claim 4, wherein the guide section is in the form of a guide bar.

13. The scum removing unit for wastewater flotation tank as claimed in claim 8, wherein the guide section is in the form of a guide bar.

14. The scum removing unit for wastewater flotation tank as claimed in claim 9, wherein the guide section is in the form of a guide bar.

15. The scum removing unit for wastewater flotation tank as claimed in claim 1, wherein the suspension arm has a plurality of scrapers fixed to the lower end thereof.

16. The scum removing unit for wastewater flotation tank as claimed in claim 2, wherein the suspension arm has a plurality of scrapers fixed to the lower end thereof.

17. The scum removing unit for wastewater flotation tank as claimed in claim 3, wherein the suspension arm has a plurality of scrapers fixed to the lower end thereof.

18. The scum removing unit for wastewater flotation tank as claimed in claim 5, wherein the suspension arm has a plurality of scrapers fixed to the lower end thereof.

19. The scum removing unit for wastewater flotation tank as claimed in claim 6, wherein the suspension arm has a plurality of scrapers fixed to the lower end thereof.

20. The scum removing unit for wastewater flotation tank as claimed in claim 7, wherein the suspension arm has a plurality of scrapers fixed to the lower end thereof.

21. The scum removing unit for wastewater flotation tank as claimed in claim 10, wherein the suspension arm has a plurality of scrapers fixed to the lower end thereof.

22. The scum removing unit for wastewater flotation tank as claimed in claim 11, wherein the suspension arm has a plurality of scrapers fixed to the lower end thereof.

23. The scum removing unit for wastewater flotation tank as claimed in claim 13, wherein the suspension arm has a plurality of scrapers fixed to the lower end thereof.

24. The scum removing unit for wastewater flotation tank as claimed in claim 14, wherein the suspension arm has a plurality of scrapers fixed to the lower end thereof.

25. The scum removing unit for wastewater flotation tank as claimed in claim 1, further comprising a coupling mechanism mounted between the driving element and the shaft mechanism.

26. The scum removing unit for wastewater flotation tank as claimed in claim 2, further comprising a coupling mechanism mounted between the driving element and the shaft mechanism.

27. The scum removing unit for wastewater flotation tank as claimed in claim 3, further comprising a coupling mechanism mounted between the driving element and the shaft mechanism.

28. The scum removing unit for wastewater flotation tank as claimed in claim 5, further comprising a coupling mechanism mounted between the driving element and the shaft mechanism.

29. The scum removing unit for wastewater flotation tank as claimed in claim 8, further comprising a coupling mechanism mounted between the driving element and the shaft mechanism.

30. The scum removing unit for wastewater flotation tank as claimed in claim 9, further comprising a coupling mechanism mounted between the driving element and the shaft mechanism.

31. The scum removing unit for wastewater flotation tank as claimed in claim 10, further comprising a coupling mechanism mounted between the driving element and the shaft mechanism.

32. The scum removing unit for wastewater flotation tank as claimed in claim 15, further comprising a coupling mechanism mounted between the driving element and the shaft mechanism.

33. The scum removing unit for wastewater flotation tank as claimed in claim 16, further comprising a coupling mechanism mounted between the driving element and the shaft mechanism.

34. The scum removing unit for wastewater flotation tank as claimed in claim 17, further comprising a coupling mechanism mounted between the driving element and the shaft mechanism.

35. The scum removing unit for wastewater flotation tank as claimed in claim 25, wherein the coupling mechanism includes a driving pulley, a driven pulley, and a pulley belt connecting the driving pulley to the driven pulley.

36. The scum removing unit for wastewater flotation tank as claimed in claim 26, wherein the coupling mechanism includes a driving pulley, a driven pulley, and a pulley belt connecting the driving pulley to the driven pulley.

37. The scum removing unit for wastewater flotation tank as claimed in claim 27, wherein the coupling mechanism includes a driving pulley, a driven pulley, and a pulley belt connecting the driving pulley to the driven pulley.

38. The scum removing unit for wastewater flotation tank as claimed in claim 28, wherein the coupling mechanism includes a driving pulley, a driven pulley, and a pulley belt connecting the driving pulley to the driven pulley.

39. The scum removing unit for wastewater flotation tank as claimed in claim 32, wherein the coupling mechanism includes a driving pulley, a driven pulley, and a pulley belt connecting the driving pulley to the driven pulley.

40. The scum removing unit for wastewater flotation tank as claimed in claim 1, wherein the rotating element is in the form of a round disc.

41. The scum removing unit for wastewater flotation tank as claimed in claim 2, wherein the rotating element is in the form of a round disc.

42. The scum removing unit for wastewater flotation tank as claimed in claim 3, wherein the rotating element is in the form of a round disc.

43. The scum removing unit for wastewater flotation tank as claimed in claim 5, wherein the rotating element is in the form of a round disc.

44. The scum removing unit for wastewater flotation tank as claimed in claim 8, wherein the rotating element is in the form of a round disc.

45. The scum removing unit for wastewater flotation tank as claimed in claim 9, wherein the rotating element is in the form of a round disc.

46. The scum removing unit for wastewater flotation tank as claimed in claim 10, wherein the rotating element is in the form of a round disc.

47. The scum removing unit for wastewater flotation tank as claimed in claim 15, wherein the rotating element is in the form of a round disc.

48. The scum removing unit for wastewater flotation tank as claimed in claim 16, wherein the rotating element is in the form of a round disc.

49. The scum removing unit for wastewater flotation tank as claimed in claim 17, wherein the rotating element is in the form of a round disc.

50. The scum removing unit for wastewater flotation tank as claimed in claim 1, wherein the suspension arm is eccentrically and pivotally connected at a pivot section to the rotating element.

51. The scum removing unit for wastewater flotation tank as claimed in claim 2, wherein the suspension arm is eccentrically and pivotally connected at a pivot section to the rotating element.

52. The scum removing unit for wastewater flotation tank as claimed in claim 3, wherein the suspension arm is eccentrically and pivotally connected at a pivot section to the rotating element.

53. The scum removing unit for wastewater flotation tank as claimed in claim 5, wherein the suspension arm is eccentrically and pivotally connected at a pivot section to the rotating element.

54. The scum removing unit for wastewater flotation tank as claimed in claim 8, wherein the suspension arm is eccentrically and pivotally connected at a pivot section to the rotating element.

55. The scum removing unit for wastewater flotation tank as claimed in claim 9, wherein the suspension arm is eccentrically and pivotally connected at a pivot section to the rotating element.

56. The scum removing unit for wastewater flotation tank as claimed in claim 10, wherein the suspension arm is eccentrically and pivotally connected at a pivot section to the rotating element.

57. The scum removing unit for wastewater flotation tank as claimed in claim 15, wherein the suspension arm is eccentrically and pivotally connected at a pivot section to the rotating element.

58. The scum removing unit for wastewater flotation tank as claimed in claim 16, wherein the suspension arm is eccentrically and pivotally connected at a pivot section to the rotating element.

59. The scum removing unit for wastewater flotation tank as claimed in claim 17, wherein the suspension arm is eccentrically and pivotally connected at a pivot section to the rotating element.

60. The scum removing unit for wastewater flotation tank as claimed in claim 1, wherein the scraper may be differently configured or shaped.

61. The scum removing unit for wastewater flotation tank as claimed in claim 2, wherein the scraper may be differently configured or shaped.

62. The scum removing unit for wastewater flotation tank as claimed in claim 3, wherein the scraper may be differently configured or shaped.

63. The scum removing unit for wastewater flotation tank as claimed in claim 5, wherein the scraper may be differently configured or shaped.

64. The scum removing unit for wastewater flotation tank as claimed in claim 8, wherein the scraper may be differently configured or shaped.

65. The scum removing unit for wastewater flotation tank as claimed in claim 9, wherein the scraper may be differently configured or shaped.

66. The scum removing unit for wastewater flotation tank as claimed in claim 10, wherein the scraper may be differently configured or shaped.

67. The scum removing unit for wastewater flotation tank as claimed in claim 15, wherein the scraper may be differently configured or shaped.

68. The scum removing unit for wastewater flotation tank as claimed in claim 16, wherein the scraper may be differently configured or shaped.

69. The scum removing unit for wastewater flotation tank as claimed in claim 17, wherein the scraper may be differently configured or shaped.
